(19) United States
(12) Patent Application Publication
(10) Pub. No.: US 2024/0165804 A1
(43) Pub. Date: May 23, 2024

(54) Environment Warped Gait Trajectory Optimization for Complex Terrains

(71) Applicant: Tencent America LLC, Palo Alto, CA (US)

(72) Inventors: Zherong PAN, Bellevue, WA (US); Xifeng GAO, Bellevue, WA (US); Kui WU, Irvine, CA (US)

(73) Assignee: Tencent America LLC, Palo Alto, CA (US)

(21) Appl. No.: 18/188,975

(22) Filed: Mar. 23, 2023

Related U.S. Application Data
(60) Provisional application No. 63/381,663, filed on Oct. 31, 2022.

(51) Int. Cl. B25J 9/16; G05B 19/4155

(52) U.S. Cl. CPC B25J 9/1664; B25J 9/1602; G05B 19/4155; G05B 2219/40519

(57) ABSTRACT

An environment warping approach is implemented to improve a robustness of contact-aware robot trajectory optimization by a change of coordinates from an ambient space to a flat space. The disclosed method warps the ambient space of a curved terrain to a warped space with a flat terrain using a optimized mapping function. A contact-aware trajectory optimization procedure is then formulated in the warped space under a set of geometrical and physical constraints with decision variables pulled back from the ambient space to the warped flat space. The decision variables are parameterized using high-order spines with a set of control parameters which are optimized in the warped space in order to generate the gait trajectory in the ambient space. For example, an objective function and constraint functions from the ambient space are pushed back to the warped space while force and rotational variables are pushed forward from the warped space to the ambient space. Such an approach, in comparison to implementations involving optimization within the ambient space only achieves a higher success rate in fining optical solutions.

### CROSS REFERENCE

This application is based on and claims the benefit of priority to U.S. Provisional Patent Application No. 63/381,663 filed on Oct. 31, 2022, which is herein incorporated by reference in its entirety.

### FIELD OF THE INVENTION

This disclosure is generally directed to design, planning, and control loop for robots and particularly describes a contact-aware gait trajectory optimization for legged robots over a curved terrain.

### BACKGROUND OF THE INVENTION

Gait trajectory generation is a core component in design, planning, and control loop for legged robots. In addition to controlling physical motion of legged robots, gait trajectories so produced, for example, may be used to render computer generated graphics in video games, virtual reality, augmented reality, and other interactive applications. The generation of gait trajectories of legged robots usually involves complex multi-variable search space optimization procedures that sometimes fail to find a solution or fall into sub-optimal local minima.

### SUMMARY OF THE INVENTION

This disclosure is directed generally to design, planning, and control loop for robots and particularly describes a contact-aware gait trajectory optimization for legged robots over a curved terrain.

In particular, an environment warping approach is implemented to improve a robustness of contact-aware trajectory optimization by a change of coordinates from an ambient space to a flat space. The methods and devices disclosed herein transform an ambient space encompassing a curved terrain to a warped yet flat space using a optimized mapping function. The curved terrain in the ambient space is correspondingly mapped to a flat surface in the warped space. A contact-aware trajectory optimization procedure is then formulated in the warped space under a set of geometrical, physical, and force constraints with decision variables pulled back from the ambient space to the warped flat space. The decision variables are parameterized using high-order spines with a set of control parameters. The set of control parameters are optimized in the warped space and used to generate the gait trajectory of the legged robot in the ambient space. Various control points are optimized in the warped space in order to generate the gait trajectory in the ambient space. For example, an objective function and various constraint functions from the ambient space are pulled back to the warped space while force and rotational variables are pushed forward from the warped space to the ambient space. Such an approach, in comparison to baseline implementations involving optimization within the ambient space only, achieves a 13-100% higher success rate in fining optimal solutions.

In some example implementations, a method for computer generation of a gait trajectory as a function of time for a legged robot moving from an origin to a destination over an ambient terrain is disclosed. The method may include establishing a flat terrain and a narrow flat neighborhood band above the flat terrain, the flat terrain and the narrow flat neighborhood band forming a three-dimensional (3D) flat space; automatically generating, using a first optimization procedure for minimizing a first objective function, a mapping function from the 3D flat space to a 3D ambient space encompassing the ambient terrain; automatically generating, using a second optimization procedure under a set of motion constraints and by minimizing a second objective function, a set of control points and time spans in the 3D flat space for parameterizing the gait trajectory using high-order spines; and automatically generating the gait trajectory of the legged robot in the 3D ambient space from the origin to the destination based on the set of control points in the 3D flat space, the time spans, and the mapping function.

In the example implementations above, the 3D ambient space and the 3D flat space are discretized using a finite element procedure with high-order shape functions.

In any one of the example implementations above, the 3D flat space is discretized into a regular grid of B-spine cells and the mapping function for each spatial dimension in the 3D flat space comprises a linear combination of the high-order shape functions.

In any one of the example implementations above, the high-order shape functions are C² continuous.

In any one of the example implementations above, the first objective function may include an integrated energy measure and a terrain mismatching measure.

In any one of the example implementations above, the integrated energy measure may be configured to represent a mapping conformity.

In any one of the example implementations above, the mapping conformity, when minimized, maximizes a preservation of angles between the 3D flat space and the 3D ambient space by the mapping function.

In any one of the example implementations above, the method may further include receiving a height profile of the ambient terrain in the 3D ambient space, wherein the terrain mismatching measure is configured to quantify a deviation of the flat terrain in the 3D flat space mapping to the ambient terrain in the 3D ambient space via the mapping function, the ambient terrain being represented by the height profile.

In any one of the example implementations above, the first optimization procedure may include an iterative process of both local and global optimization.

In any one of the example implementations above, the legged robot may include a torso attached with a plurality of end-effectors; and the gait trajectory of the legged robot is represented by a torso position, a torso orientation, end-effector positions, and end-effector forces, each as a function time.

In any one of the example implementations above, the set of motion constraints may include a set of geometrical constraints, a set of physical motion constraints, and a force constraint.

In any one of the example implementations above, the set of physical motion constraints may include Newton-Euler's equations relating the end-effector forces and gravity to a translation and rotation of the legged robot; and the force constraint requires that the end-effector forces lie within a fraction cone during contacts of the end-effectors mith the ambient terrain.

In any one of the example implementations above, the set of geometrical constraints may include: the end-effector positions being on or above the ambient terrain in the 3D ambient space; the end-effector positions being within a reachable set of distances relative to the torso position in the 3D ambient space.

In any one of the example implementations above, the set of geometric constraints are represented in the 3D flat space by pulling back the set of geometric constraints from the 3D ambient space.

In any one of the example implementations above, the set of physical motion constraints and the force constraint are tested during the second optimization procedure at a fixed set of time instances.

In any one of the example implementations above, the set of physical motion constraints are represented by a Position-based Centroid Dynamics Model (PCDM) in a push-forward form in the 3D ambient space.

In any one of the example implementations above, the physical motion constraints are represented as a minimizer of a combined inertial and potential energy.

In any one of the example implementations above, the set of control points in the 3D flat space may include a first set of control points for the torso position in the 3D flat space; a second set of control points for the torso orientation in the 3D flat space; a third sets of control points for the end-effector positions in the 3D flat space; and a fourth sets of control points for the end-effector forces in the 3D flat space.

In any one of the example implementations above, the second objective function uses the set of control points as optimization variables.

In some example implementations, an electronic device having a memory for storing computer instructions and a processor is disclosed. The processor, when reading the computer instructions from the memory for execution, is configured to implemented anyone of the methods above.

In some example implementations, a computer-readable non-transitory storage medium for storing computer code is disclosed. The computer code, when executed by a processor of an electronic device is configured to cause the electronic device to implemented any one of the example methods above.

### BRIEF DESCRIPTION OF THE DRAWINGS

For a more complete understanding of the invention, reference is made to the following description and accompanying drawings, in which:

FIG. 1 illustrates an example legged robot modeled as traversing an ambient terrian in an ambient space mapped to a flat terrian in a warped flat space;

FIG. 2 shows a logic and data flow of an example method embodiment of the current disclosure;

FIG. 3 illustrates example key notations in a contact phase-based gait trajectory optimization;

FIG. 4A-FIG. 4D illustrate example optimized terrains with smooth function ϕ mapping narrow band areas around the terrains;

FIG. 5 illustrates relative conformal error over a set of regularly sampled points on the terrain in FIG. 4A;

FIG. 6A-FIG. 6H illustrate convergence history of a local-global optimization method and a Newton optimization method for obtaining a mapping function from a warped flat space to an ambient space;

FIG. 7A-FIG. 7C illustrate example trajectories of a legged robot walking on curved terrains;

FIG. 8 illustrates success rate of a warped space optimization method and a baseline method for the terrain of FIG. 4A;

FIG. 9 illustrates a comparison of computational time for generating a trajectory of 10 seconds with different walking directions for a warped space method and a baseline method;

FIG. 10A and FIG. 10B illustrate a robot climbing up a hill of FIG. 4C and FIG. 4D, respectively;

FIG. 11 illustrates an iteration-wise constraint violation of a warped space method and a baseline method for a hill-climbing trajectory optimization; and

FIG. 12 illustrates a device and computer system and the components therein for implementing the various method embodiments of the current disclosure.

### DETAILED DESCRIPTION

### Contact-Aware Gait Trajectory Optimization in an Ambient Space

Movement of legged robots in a terrain may be described by their gait trajectories as a function of time. Such a terrain may generally be curved and may sometimes be rugged. The movement of the legged robots may obey a set of physics constraints, geometrical constraints, force constraints, and other constraints. Gait trajectory generation or simulation constitutes a core component in the design, planning, and control loop for such legged robots. In addition to controlling physical motion of legged robots, gait trajectories so produced, for example, may be used to render computer-generated graphics in video games, virtual reality, augmented reality, and other interactive applications. The generation of gait trajectories of legged robots usually involves complex multi-variable search space optimization procedures.

Gait trajectory optimization settings may be categorized into contact-aware and non-contact-aware. A non-contact-aware optimizer may be configured to search for sequences of robot gaits or control signals. In some implementations, non-contact-aware optimizers may also be configured to plan motions through contacts via model predictive control combined with smooth approximate contact models or stochastic optimizations. However, these methods suffer from gradient explosion, preventing them from finding complex motions over a long horizon.

In some implementations, a complex contact-aware gait trajectory optimization may be performed in the ambient space. The term “contact-aware” is used to describe a consideration of physics and force restrictions due to contacts between one of more end-effectors of a legged robot with the ambient terrain. For example, contact-aware trajectory optimization may adopt an augmented high-dimensional joint search space of robot gaits, contact points, and forces over a long horizon. Such implementations may use explicit constraints to enforce the regularity of contacts. As an example of such constraints, it may be required that external forces (other than gravity) can only appear when the robot touches the environments. With the augmented formulation, constraints may become differentiable, locally supported, and do not suffer from ill-conditioned gradients, enabling an optimizer to discover motions with many contact state changes. An inherent downside of such formulation is the high-dimensional search space, where only locally optimal solutions can be found within a tractable computational budget. Example interior point optimizers can take hours to find long trajectories of full body motions even on advanced and efficient GPU. Furthermore, optimizers can oftentimes fail to find feasible solutions or converge to sub-optimal motions, which may correspond to the robots taking unnecessarily small steps or performing unstable maneuvers. In general, such contact-aware gain trajectory generation and optimization in the ambient space is a challenging non-convex programming problem, especially for complex terrain shapes, where various numerical algorithms can fail to find a solution or fall into local minima.

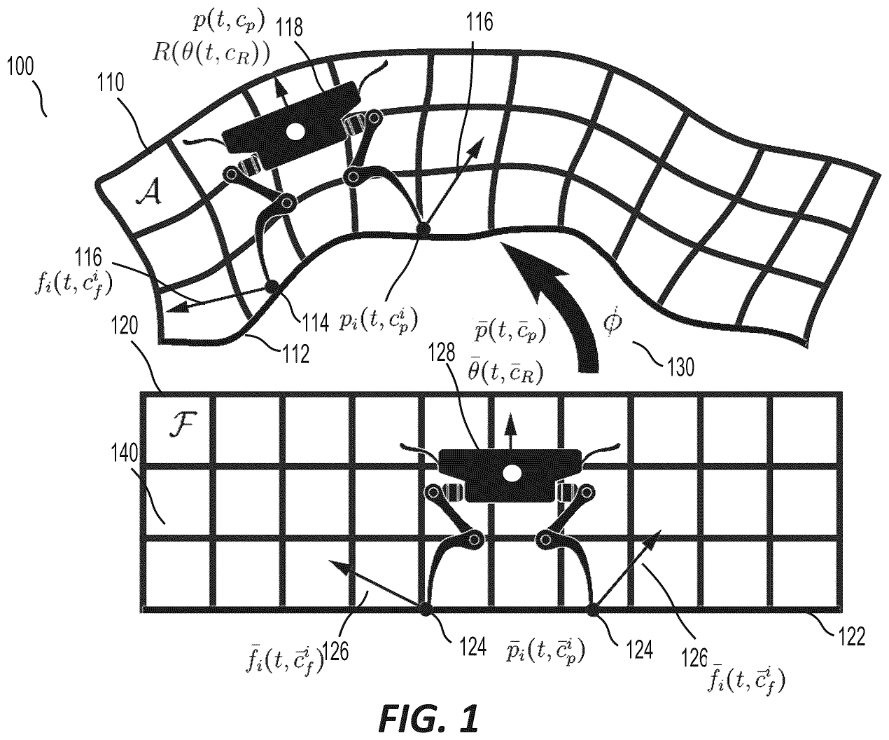

Such optimization failure is much more substantial in a contact-aware setting than in non-contact-aware cases due to the additional complementary constraints. Even worse, a robot may need to traverse on uneven terrains, as illustrated in curve 112 as a bottom of an ambient space 110 of FIG. 1. The existence of irregular terrain shapes can significantly complicate the landscapes of objective and constraint functions, further decreasing the chances of finding a solution. Additional techniques, such as multi-start optimization and stochastic optimization, may improve the quality of optimized trajectories, but they are costly to be applied in long-horizon contact-aware settings, particularly for gait trajectory generation in real-time interactive application.

### Environmental Warping: General Approaches

The term environment warping may be used to refer to a transformation of the ambient space into a warped space for optimization. Environment warping belongs to a broader category of techniques on surface and volume parameterization. For example, environment warping may be designed to discretize and numerically solve partial differential equations or to generate detailed appearances in virtual environments. For another example, environment warping may be employed in parameterization of workspace in motion planning problems for robots. Environment warping may rely on the parameterization of the infinite ambient space 110 via the solution of exterior Laplace equation using a boundary element method. Such a technique is usually time-consuming to compute. Further, its solution is usually represented as a boundary integral that is also singular on the domain boundary itself. These properties make such a technique inappropriate for contact-aware trajectory optimization.

### Contact-Aware Gait Trajectory Optimization in Warped Flat Space: Overall Implementations

As described in further detail in the various sections below, example implementations of this disclosure use an environment warping approach to improve a robustness of contact-aware robot trajectory optimization by a change of coordinates from an ambient space to a warped but flat space. The disclosed methods warp the ambient space of a curved terrain to a warped space with a flat terrain using a locally injective mapping function optimized using a finite element parameterization. The mapping function are generated as conformal as possible to the ambient space. A contact-aware trajectory optimization procedure is then formulated in the warped space under a set of geometrical, physical, and force correctness constraints with decision variables pulled back (or mapped) from the ambient space to the warped flat space. The decision variables are parameterized using high-order spines with a set of control parameters which are optimized in the warped space in order to generate the gait trajectory in the ambient space. For example, an objective function and constraint functions from the ambient space are pushed back to the warped space while force and rotational variables are pushed forward from the warped space to the ambient space. These implementations free numerical optimizers from tuning the trajectories to fit changing terrain shapes, leading to better numerical conditioning and fewer local minima. Numerical results show that the methods and devices disclosed herein outperform direct trajectory optimization in terms of both success rates and quality of solutions. Such an approach, in comparison to implementations involving optimization within the ambient space only (referred to as the baseline approach), achieves a higher success rate in finding higher quality optimal solutions.

These example implementations generally include generating a representation of a smooth map for warping an ambient space encompassing a curved terrain; a finite-element-based optimization procedure to generate a locally injective terrain warping function; and a warped-space formulation for contact-aware trajectory optimization, as described in further detail below. Specifically, the ambient space may be discretized using the finite element method with high-order continuous shape functions. The finite element techniques can be employed to deal with a larger variety of objective functions in optimization than other techniques such as boundary element methods. For example, as shown in further detail below, an angle-preserving conformal warping may perform better for the optimization task at hand than a smooth warping produced by solving the Laplace equation, and such angle-preserving conformal warping may only be realized via the finite element method.

These example implementations further use various push-forward and pull-back operators in formulating the contact-aware trajectory optimizations. To handle multiple types of decision variables, the order of continuity of a smooth map function from the 3D flat space to the 3D ambient space is carefully controlled during the optimization of the decision variables to ensure that all the variables are sufficiently smooth to be properly handled by gradient-based optimizers. In order to represent robot orientations in SO(3), an operator for projecting a point of the ambient space to its closest neighbor on SO(3) may also be introduced in formulating the contact-aware trajectory optimization, as described in further detail below.

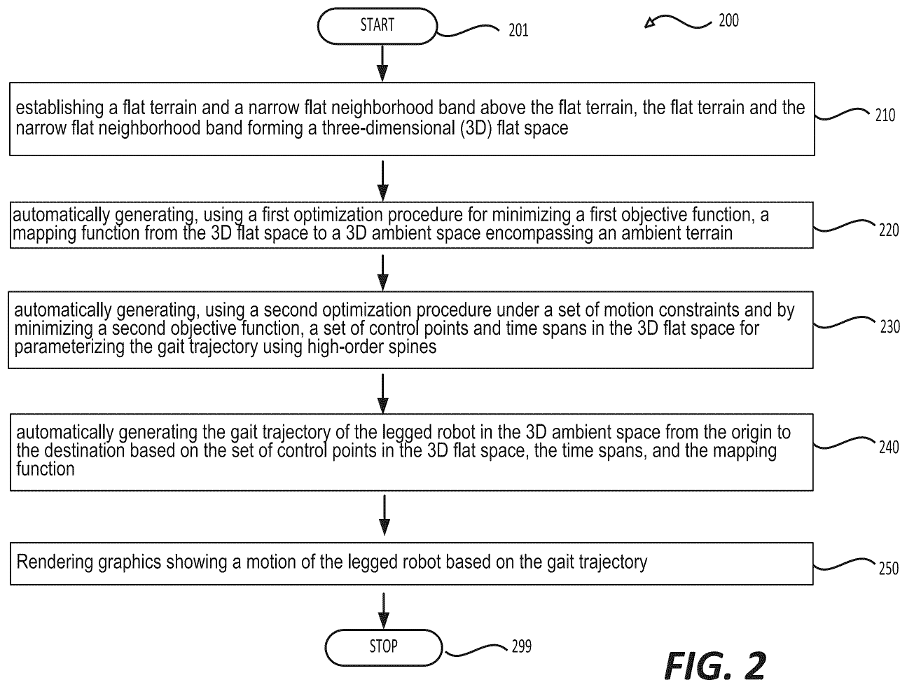

An example process for generating a gait trajectory for a legged robot from an origin to a destination in the ambient terrain is shown in the logic and data flow 200 of FIG. 2. As describe in further detail below, the legged robot may include a torso attached with a plurality of end-effectors. The gait trajectory of the legged robot may be represented by a torso position, a torso orientation, end-effector positions, and end-effector forces, each as a function time.

As shown in FIG. 2, the example logic and data flow 200 start at step 201. In step 210, a flat terrain and a narrow flat neighborhood band above the flat terrain is established. The flat terrain and the narrow flat neighborhood band forms a three-dimensional (3D) flat space. The flat terrain constitutes the bottom of the 3D flat space. As further described below, the 3D flat space (and correspondingly the ambient space associated with the ambient terrain) may be discretized using a finite element procedure with high-order basis shape functions. For example, the 3D flat space may be divided into regular grid, representing, for example, tri-cubic B-spline cells. In some implementations, the high-order basis shape functions may be C² continuous.

In step 220, a mapping function from the 3D flat space to a 3D ambient space encompassing the ambient terrain may be automatically generated using a first optimization procedure for minimizing a first objective function. The ambient terrain may be predefined and may be a generally curved terrain for the legged robot to traverse. The first objective function, for example, may include an integrated energy measure and a terrain mismatching measure. For example, the integrated energy measure, as described in further detail below, may be configured to represent a mapping conformity. Such a mapping conformity, when minimized, may facilitate maximization of a preservation of angles between the 3D flat space and the 3D ambient space by the mapping function. The terrain mismatching measure, additionally, may be configured to quantify a deviation of the flat terrain in the 3D flat space mapping to the ambient terrain in the 3D ambient space via the mapping function. The ambient terrain may be represented by a height profile of the ambient terrain. The minimization of the terrain mismatching measure thus help mapping the flat terrain in the 3D flat space to the predetermined curved ambient terrain (represented by the height profile) in the ambient space as much as possible. Furthermore, the first optimization procedure in step 220, as described in further detail below, may include an iterative process of both local and global optimization.

In Step 230, a set of control points and time spans in the 3D flat space may be automatically generated using a second optimization procedure under a set of motion constraints and by minimizing a second objective function for parameterizing the gait trajectory using high-order spines. For example, the set of motion constraints may include different types of constraints, including but not limited to a set of geometrical constraints, a set of physical motion constraints, and a force constraint. The set of physical motion constraints, for example, may be represented by Newton-Euler's equations relating the end-effector forces and gravity to a translation and rotation dynamics of the legged robot driven by external forces. The force constraint, for example, may require that the end-effector forces lie within a friction cone during contacts of the end-effectors with the ambient terrain.

The set of geometrical constraints, for example, may require that the end-effector positions be on or above the ambient terrain in the 3D ambient space and that the end-effector positions be within a reachable set of distances and/or orientation relative to the torso position and/or orientation in the 3D ambient space. In other words, it may be required that the end-effectors of the robot be incapable of penetrating the ambient terrain and that the there is is a limit as to the extent that the end-effectors of the robot can extend away from its torso.

For the second optimization procedure above, the set of geometric constraints may be represented in the 3D flat space by pulling back the set of geometric constraints from the 3D ambient space using a set of pull-back operators. In addition, the set of physical motion constraints and the force constraint may be tested during the second optimization procedure at a fixed set of time instances rather than all time instances. As such, the set of physical motion constraints (based on the Newton-Euler equations) may be represented by a Position-based Centroid Dynamics Model (PCDM) in a push-forward form in the 3D ambient space in order to avoid a pull-back to the 3D flat space which would require rotational trajectory to be C² continuous that may not always be achievable via the mapping function discretized using cubit basis function described above and in further detail below. In some example implementations, the physical motion constraints may be represented as a minimizer of a combined inertial and potential energy.

In some example implementations, the set of control points in the 3D flat space may include a first set of control points for the torso position in the 3D flat space; a second set of control points for the torso orientation in the 3D flat space; a third sets of control points for the end-effector positions in the 3D flat space; and a fourth sets of control points for the end-effector forces in the 3D flat space. In some example implementations, the the second objective function may use the set of control points as optimization variables.

In Step 240, the gait trajectory of the legged robot in the 3D ambient space may be automatically generated from the origin to the destination based on the set of control points in the 3D flat space, the time spans, and the mapping function.

Finally in Step 250, graphics showing a motion of the torso and the end-effectors of the legged robot may be generated based on the gait trajectory and may be displayed for viewing.

Detailed description of the various example steps above is further provided below.

### Contact-Aware Trajectory Optimization: Robot Trajectory Representation

In the disclosure below and unless specified otherwise, uppercase letters and symbols are used for matrices, functions, and constants, whereas lowercase letters and symbols are used for scalars and vectors. The vectors, such as the position and force vectors, implicitly contain their components in relevant spatial dimensions. In the examples below, a phased space formulation relying on distinct phases of motion may be used as an example representation and parameterization of the description of the legged robot.

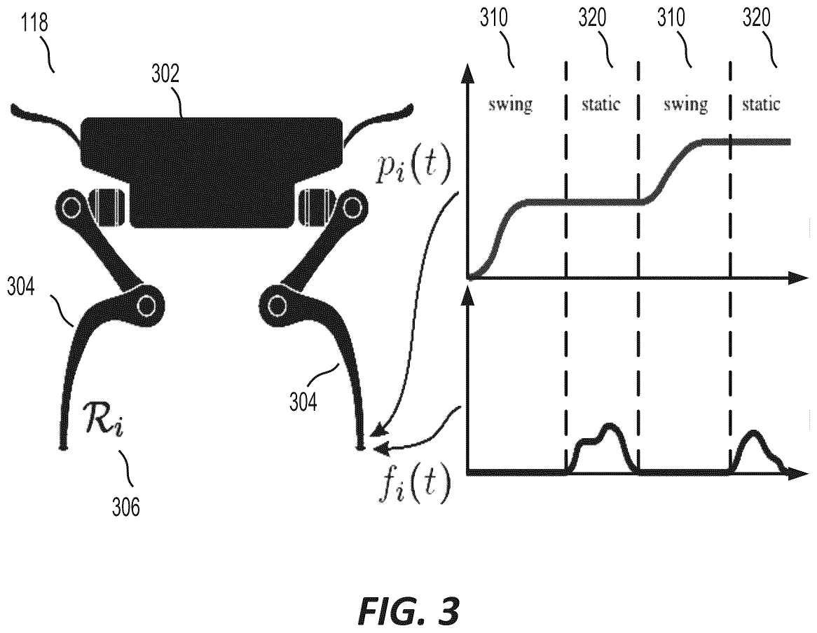

As shown in FIGS. 1 and 3, a legged robot 118 traversing an ambient terrain 112 in an ambient space 110 may be modeled as including a torso 302 with orientation trajectory R(t) and translation trajectory p(t) and a plurality of end effectors (or legs). For example, the robot has a number E of end-effectors located at pᵢ(t) exerting contact forces fᵢ(t), where i=1, . . . , E representing an a particular end-effector and t∈[0, T] is the time variable. The torso position trajectory p(t) may be parameterized using high-order splines with control points cₚ, denoted as p(t) [symbol] p(t, cₚ), as indicated along side label 118 in FIG. 1. The torso orientation is represented using three Euler angles θ, which in turn is parameterized using high-order splines with control points c_{R}, denoted as R(t) [symbol] R(θ(t, c_{R})), as also indicate along side label 118 in FIG. 1.

A key to the phase-based formulation includes an alternating parameterization of pᵢ(t) and fᵢ(t). As shown in the graphs in the right panel of FIG. 3, where the horizontal axis represents time and the vertical axis represents either the position (top graph) or the force (bottom graph), each robot contact trajectory may be divided into an alternating sequence of static phases 320 and swing phases 310. During the static phases 320, pᵢ(t) lies statically on the ground (invariant with time during the static phase) and fᵢ(t) can be non-zero, while during the swing phases 310, pᵢ(t) can freely move above the ground while fᵢ(t) must be zero. As a result, the position-force complementarity may be implicitly encoded without requiring additional constraints. Such a parameterization can be realized by two alternating sequences of high-order splines.

In some example implemenatins, flexibility may be further improved by treating the time spans of each static phase and swing phase as additional decision variables, under the constraints that all the time spans are positive and sum up to T. The control points as well as the time spans for the ith contact point and force sequence may be represented as cₚⁱ and c_{f}ⁱ, respectively. As a result, the end-effector translation trajectory in each of the three spatial dimensions may be divided into segments delineated by time knots (time spans) and each segments being determined by the control points near the segment and spine basis functions, expressed as pᵢ(t) [symbol] pᵢ(t, cₚⁱ). Similarly, the force trajectory with its control points may be expressed as fᵢ(t) [symbol] fᵢ(t, c_{f}ⁱ). A concatenation of all the decision variables may be denoted as c [symbol] (c_{R}, cₚ, cₚⁱ, c_{f}ⁱ).

### Contact-Aware Trajectory Optimization: Optimization Constraints in the Ambient Space

An example baseline gait trajectory optimization formulation expressed in an ambient space may take the following form:

$${argmin}_{c} E ( c ) s . t . \qquad ( 1 )$$

$$\{ \begin{matrix}∀ t ∈ {𝒯}_{d} : m \ddot{p} ( t ) = {\sum }_{i = 1}^{E} {f}_{i} ( t ) + mg \\ I \dot{ω} ( t ) + ω ( t ) \times I ω ( t ) = {R ( t )}^{T} {\sum }_{i = 1}^{E} ( {p}_{i} ( t ) - p ( t ) ) \times {f}_{i} ( t )\end{matrix} \qquad ( 2 )$$

$$\{ \begin{matrix}∀ t ∈ {𝒯}_{static}^{i} ( {c}_{p}^{i} ) : {z}^{T} {p}_{i} ( t , {c}_{p}^{i} ) = h ( {p}_{i} ( t , {c}_{p}^{i} ) ) \\ ∀ t ∈ {𝒯}_{swing}^{i} ( {c}_{p}^{i} ) : {z}^{T} {p}_{i} ( t , {c}_{p}^{i} ) \geq h ( {p}_{i} ( t , {c}_{p}^{i} ) )\end{matrix} \qquad ( 3 )$$

$$∀ t ∈ {𝒯}_{d} : {R ( t )}^{T} ( {p}_{i} ( t ) - p ( t ) ) ∈ {ℛ}_{i} \qquad ( 4 )$$

$$∀ t ∈ {𝒯}_{d} : ‖ [ I - {n}_{i} ( t ) {{n}_{i} ( t )}^{T} ] {f}_{i} ( t ) ‖ \leq 𝓋 {{n}_{i} ( t )}^{T} {f}_{i} ( t ) , \qquad ( 5 )$$

The example formulation above includes both an optimization formulation (Equation (1) and three types of integrity constraints ensuring physical, geometric, and force correctness (Equation (2)-Equation (5). These different types of constraints are referred to as physical or physics constraints, geometric constraints, and force or force correctness constraints, respectively.

The physical constraints in Equation (2) ensure that the robot torso complies with the Newton-Euler's motion equation, where I represents the inertia tensor and ω(t) is the angular velocity of the robot, both measured at the local frame of reference. The symbol m represents the robot torso mass and g is the gravitational coefficient. In some implementations, the physical constraints in Equation (2) may be tested at fixed time intervals or time instances denoted as a discrete set [symbol] rather than all time instances.

Geometrically, the robot environment or ambient terrain may be modeled as a heightfield h(x,y): [symbol] ²→ [symbol] , mapping a horizontal point in the corresponding three-dimensional (3D) ambient space to its vertical ground height. The geometric constraints in Equation (3) indicate that the robot's end-effectors make contacts with the heightfield during the static phases. While during the swing phases, the end-effectors cannot penetrate the terrain. In some implementations, the geometric constraints in Equation (3) may be tested at a set of discrete time instances [symbol] and [symbol] . Since timing of phase-changes could be optimized, [symbol] and [symbol] are functions of cₚⁱ.

Additionally and as another geometric constraint, each robot's end-effector pᵢ must be within a reachable set [symbol] ᵢ relative to the torso, shown as 306 in FIG. 3. Such a geometric constraint is formulated in Equation (4) and, for example, may be tested at a fixed set of time instances [symbol] , same as those for the geometric constraints in Equation (2).

The force constraints in Equation (5) require that contact forces lie in the frictional cone during each static phase, where v represents the frictional coefficient and the same test set [symbol] of time instances. n(t) represents the normal direction of terrain calculated as:

n(t) [symbol] (−∇ₓh, −∇_{y}h, 1)/∥(−∇ₓh, −∇_{y}h, 1)∥.

In the optimization formulation, the operator “argmin” represents a minimization optimization. The objective function E(c) could include additional cost functions formulating the control task. Equation (1) may be solved, for example, by gradient-based optimizers. Such gradient-based optimization solver may require all the objective and constraint functions to be at least differentiable. As a result, the heightfield in the constraints above should be sufficiently smooth. In some implementations, such sufficient smoothness may be achieved by fitting the heightfield via spline patches as described in further detail below.

### Contact-Aware Trajectory Optimization: Finite Element Environment Warping Function Formulation

An example mapping function from the 3D flat space to the 3D ambient space is described in further detail in the disclosure below. As shown in FIG. 1, the 3D ambient space 110 may be referred to as [symbol] , whereas the 3D flat space (or the warped space) 120 may be referred to as [symbol] . A pull-back operator may be referred to as an operator that maps a function (as an operand) from one manifold to the other via a smooth mapping function. The optimization methods disclosed herein may be interpreted as a pull-back operator based on a mapping function ϕ for the optimization formulation in Equation (1), from the ambient space [symbol] 110 to a warped space [symbol] 120. The example smooth mapping function ϕ is described below. The pull-back operator is formulated next.

In some example implementations, rather than using an [symbol] -space regular grid to resample the solution of an exterior Laplace equation, which warps the entire ambient space, a [symbol] -space regular grid for discretizing only a narrow band neighborhood above the terrain h(x,y) may be used, as illustrated by 140 in FIG. 1.

In some example implementations, tri-cubic B-spline basis may be used as shape functions for a construction of the smooth mapping function ϕ. For example, the [symbol] space grid may include Nₓ×N_{y}×N_{z} tri-cubic, B-spline cells and (Nₓ+3)×(N_{y}+3)×(N_{z}+3) control points (for determining each of N curve segments of the smooth mapping function with, for example, 4 control points for each segment). Each control point may be associated with a 3D mapped point denoted as ψᵢⱼₖ, i=1, . . . , Nₓ+3, j=1, . . . , N_{y}+3, k=1, . . . , N_{z}+3 and a shape function [symbol] ᵢⱼₖ(x): [symbol] ³→ [symbol] . For any x∈[0, Nₓ]×[0, N_{y}]×[0, N_{z}], the smooth map ϕ(x) may be defined as:

$$ϕ ( x ) = {\sum }_{i = 1}^{{N}_{x} + 1} {\sum }_{j = 1}^{{N}_{y} + 1} {\sum }_{k = 1}^{{N}_{z} + 1} {φ}_{ijk} {ℬ}_{ijk} ( x ) .$$

A Jacobian matrix denoted as J(x) [symbol] ∇ₓϕ may be further defined in order to use it to formulate the push-forward operator from the [symbol] space to the [symbol] space. The smooth map as constructed above endows several properties, making it suitable for defining the push-forward and pull-back operators in contact-aware trajectory optimizations. First, ϕ can be efficiently computed since the shape function [symbol] (x) is only locally supported with non-zero values only on a 4×4×4 neighboring grid. Second, the shape function and thus ϕ(x) is C²-continuous over the entire [symbol] ³. As further described below, C²-continuity is just enough for all the constraints above to have well-defined Jacobian matrices. Third, although only a narrow band neighborhood is discretized, ϕ(x) is well-defined and differentiable outside such narrow band. This property is important when used with infeasible optimization algorithms, which allow solutions to be temporarily outside the feasible domain.

### Contact-Aware Trajectory Optimization: Warping Function Optimization

The warping function above may be optimized by a first optimization procedure in order to obtain the set of control points that defines the coefficients for linear combination of the shape functions for determining ϕ. An example for this first optimization procedure is described in further detail below.

The finite element method above parameterizes the mapping function ϕ using the control points ψᵢⱼₖ function as decision variables in an optimization procedure to obtain ϕ. In some example implementations, the control points ψᵢⱼₖ are defined as minimizer of the following integrated energy:

Eₘₐₚ [symbol] ∫_{[0,N}_{ₓ}_{]×[0,N}_{_{y}}_{]×[0,N}_{_{z}}_{]}ρ(x, ψᵢⱼₖ)dv,

where ρ represents an energy density function. In practice, evaluating the above integral for a general, analytic function ρ may be intractable. As such, Gauss quadrature may be used instead for an approximation. Unlike the boundary element method, which can only handle ρ with known fundamental solutions, the finite element method allows much more flexibility in choosing ρ. For example, if ρ is chosen as the Dirichlet energy, then the Laplace equation may be recovered. Instead, since robot orientations need to be represented, it may be best for ϕ to preserve angles. In other words, the push-forward operator may be closed under SO(3). Smooth maps with this property are denoted as conformal maps. Although perfectly conformal maps are not realizable in 3D, the following energy may be used for the optimization procedure to make ϕ as conformal as possible:

$$ρ ( x , {φ}_{ijk} ) {=}^{△} {‖ J - {UV}^{T} {\vert \sum \vert}^{1 / 3} ‖}^{2} - μ {\sum }_{i = 1}^{3} log ( {\sum }_{i} ) ,$$

In the energy formulation above, the Singular Value Decomposition (SVD) of the Jacobian is denoted as: J=UΣV^{T} and the ith singular value as Σᵢ. The second term above ensures that the Jacobian have positive singular values and that the smooth map ϕ is locally injective. The symbol μ above represents a small positive weight of log-barrier functions.

As a geometrical constrain for the first optimization procedure, the bottom of the mapped space [symbol] should be aligned with the given ambient terrain h(x,y). This may be included in an additional energy objective. This is achieved using a terrain matching objective function:

E_{match} [symbol] ∫_{[0,N}_{ₓ}_{]×[0,N}_{_{y}}_{]×{0}}∥ϕ₂(x)−h(ϕ₀(x), ϕ₁(x))∥²ds,

where ϕᵢ(x) is the ith element of ϕ(x). In some example implementations, the above integral may also be approximated using Gauss quadrature.

Considering both objectives above, we define a first objective function for the first optimization procedure above in order to determine the control points for defining the smooth mapping function ϕ as:

$${ψ}_{ijk}^{*} = {argmin}_{{ψ}_{ijk}} {E}_{map} + {E}_{match} . \qquad ( 6 )$$

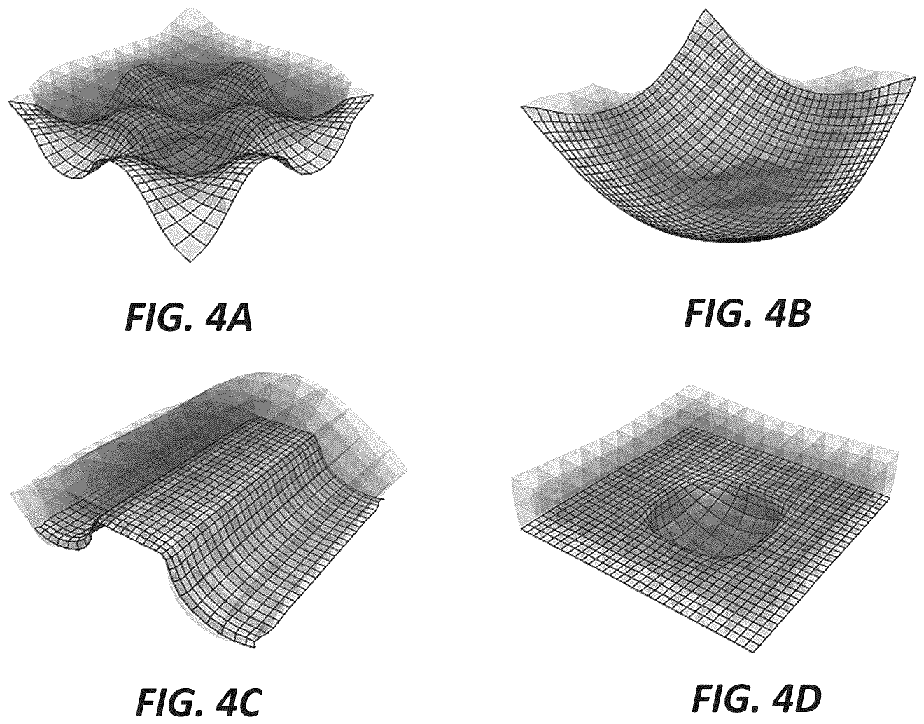

In some example implementations, the following techniques may be used to solve for optimal ψ*ᵢⱼₖ. For example, If μ=0 then the optimization can be solved in an alternating local-global manner, as shown by the example optimization algorithm in Algorithm 1 below. The example Algorithm 1 involves an iterative optimization procedure that considers both local and global conditions. The example Algorithm 1 is guaranteed to converge because the energy is monotonically decreasing over iterations. This method ignores the gradient of UV^{T}|Σ|^{1/3} and h(ϕ₀(x), ϕ₁(x)) with respect to ψᵢⱼₖ, leading a quadratic objective function with a fixed lefthand side. As a result, a Hessian matrix only needs to be factorized once and the iterative cost becomes extremely low. Some examples of optimized maps are illustrated in FIGS. 4A-4D.

Algorithm 1 Local-Global Optimization of ψᵢⱼₖ

| 1: | for iteration k = 1, 2, 3, . . . do | |
|---|---|---|
| 2: | for each Gauss quadrature sample point x do | |
| 3: | J * (x) ← UV^{T}\|Σ\|⅓ | [symbol] Local |
| 4: | for each Gauss quadrature sample point x do | |
| 5: | h * (x) ← h(ϕ₀ (x), ϕ₁ (x)) | [symbol] Local |

| | |
|---|---|
| 6: | ${ψ}_{ijk}^{*} ← {arg min}_{{ψ}_{ijk}} \{ \begin{matrix}\int {‖ J ( x ) - {J}^{*} ( x ) ‖}^{2} dv + \\ \int {‖ {ϕ}_{2} ( x ) - {h}^{*} ( x ) ‖}^{2} ds\end{matrix} ⊳ Global$ |

However, μ>0, then a full blown Gauss-Newton technique may be used with explicit line search to ensure that J(x) lies in the feasible domain with positive singular values Σᵢ.

### Contact-Aware Trajectory Optimization in Warped Space

Once the smooth map ϕ is determined, it may then be used to define pull-back operators for each constraint in Equation (1)-Equation (5) from the [symbol] to the [symbol] space. A symbol ⋅̅ is used in the disclosure below to denote variables in the warped space [symbol] . The warped-space trajectory optimization and constraints may be formulated as follows:

$$\begin{matrix}E ( \overline{c} ) & \overline{c} {=}^{Δ} ( {\overline{c}}_{R} , {\overline{c}}_{p} , {\overline{c}}_{p}^{i} , {\overline{c}}_{f}^{i} , )\end{matrix} s . t . \qquad ( 7 )$$

$$\{ \begin{matrix}∀ t ∈ {𝒯}_{static}^{i} ( {\overline{c}}_{p}^{i} ) : & {𝓏}^{T} {\overline{p}}_{i} ( t , {\overline{c}}_{p}^{i} ) = h ( {\overline{p}}_{i} ( t , {\overline{c}}_{p}^{i} ) ) \\ ∀ t ∈ {𝒯}_{swing}^{i} ( {\overline{c}}_{p}^{i} ) : & {𝓏}^{T} {\overline{p}}_{i} ( t , {\overline{c}}_{p}^{i} ) \geq h ( {\overline{p}}_{i} ( t , {\overline{c}}_{p}^{i} ) )\end{matrix} \qquad ( 8 )$$

$$\begin{matrix}∀ t ∈ {𝒯}_{d} : & ‖ [ I - {𝓏𝓏}^{T} ] {\overline{f}}_{i} ( t , {\overline{c}}_{f}^{i} ) ‖\end{matrix} \leq v {𝓏}^{T} {\overline{f}}_{i} ( t , {\overline{c}}_{f}^{i} ) \qquad ( 9 )$$

$$\{ \begin{matrix}∀ t ∈ {𝒯}_{d} : & R ( {\overline{θ} ( t , {\overline{c}}_{R} )}^{T} {𝒫 [ J ( \overline{p} ( t , {\overline{c}}_{p} ) ) ]}^{T} \\ & ( ϕ ( {\overline{p}}_{i} ( t , {\overline{c}}_{p}^{i} ) - ϕ ( \overline{p} ( t , {\overline{c}}_{p} ) ) ) ∈ {ℛ}_{i}\end{matrix} \qquad ( 10 )$$

$$\{ \begin{matrix}{\sum }_{i} {f}_{i =} \frac{M}{Δ {t}^{2}} ( p ( t ) - 2 p \_ + p \_\_ ) \\ {\sum }_{i} ( {p}_{i} ( t ) - p ( t ) ) \times {f}_{i} ( t ) = \frac{ρ}{Δ {t}^{2}} {\int }_{x ∈ Ω} ( 2 R \_ x - R \_\_ x ) \times R ( t ) xdv\end{matrix} , \qquad ( 11 )$$

Again, the constraints above include both the geometrical, physical, and force constraints. The formulation of each of these constraints above are described in further detail ielow.

With respect to the geometric constraints of Equation (3) corresponding to the end-effector position sequence pᵢ(t, cₚⁱ) being on the predefined terrain in [symbol] (110 of FIG. 1), a warped-space position sequence p̅ᵢ(t, c̅ₚⁱ) in [symbol] may be introduced, as shown along side the robot's end-effectors 124 in FIG. 1. Since the terrain is mapped to the z=0 plane in [symbol] 140 and the spline p̅ᵢ is linear in its control points c̅ₚⁱ, position correctness constraints also take the linear form of Equation (8).

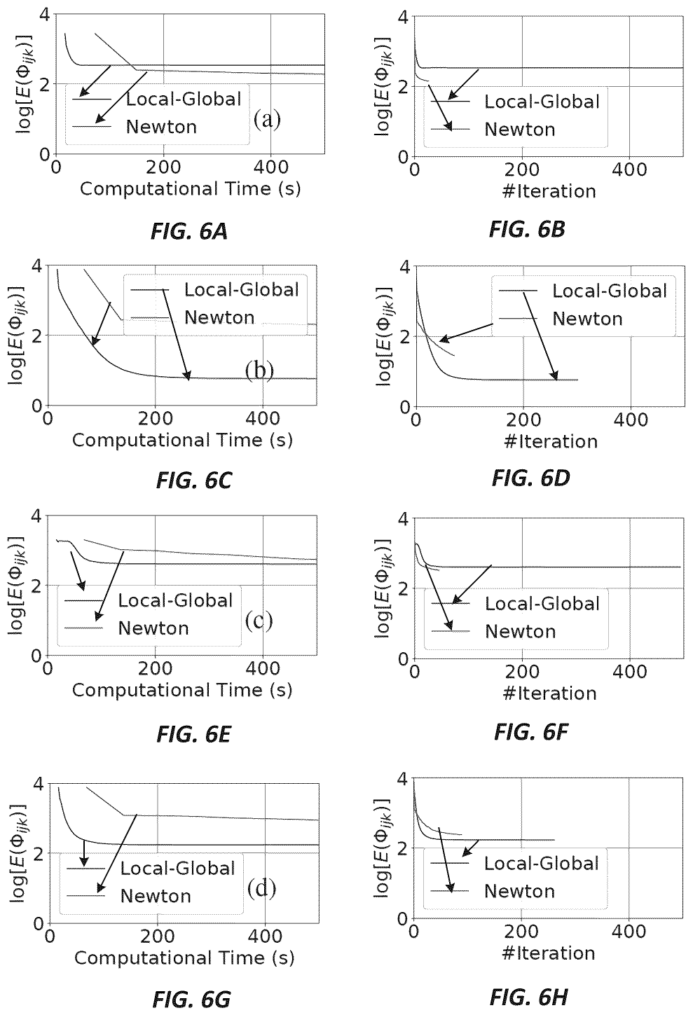

With respect to the force correctness constraints of Equation (5) in [symbol] , a force sequence f̅ᵢ(t, c̅_{f}ⁱ) in tangent space [symbol] (p̅ᵢ(t, c̅ₚⁱ)) may be defined in [symbol] , as shown along side 126 of FIG. 6, corresponding to fᵢ(t, c_{f}ⁱ) in [symbol] (ϕ(p̅ᵢ(t, c̅ₚⁱ))) in [symbol] . The force sequence f̅ᵢ(t, c̅_{f}ⁱ) maps to [symbol] the push orward operator:

fᵢ(t) [symbol] J(p̅ᵢ(t, c̅ₚⁱ))f̅ᵢ(t, c̅_{f}ⁱ).

Similarly, the normal direction is mapped to [symbol] as:

nᵢ(t) [symbol] J(p̅ᵢ(t, c̅ₚⁱ))z/∥J(p̅ᵢ(t, c̅ₚⁱ))z∥.

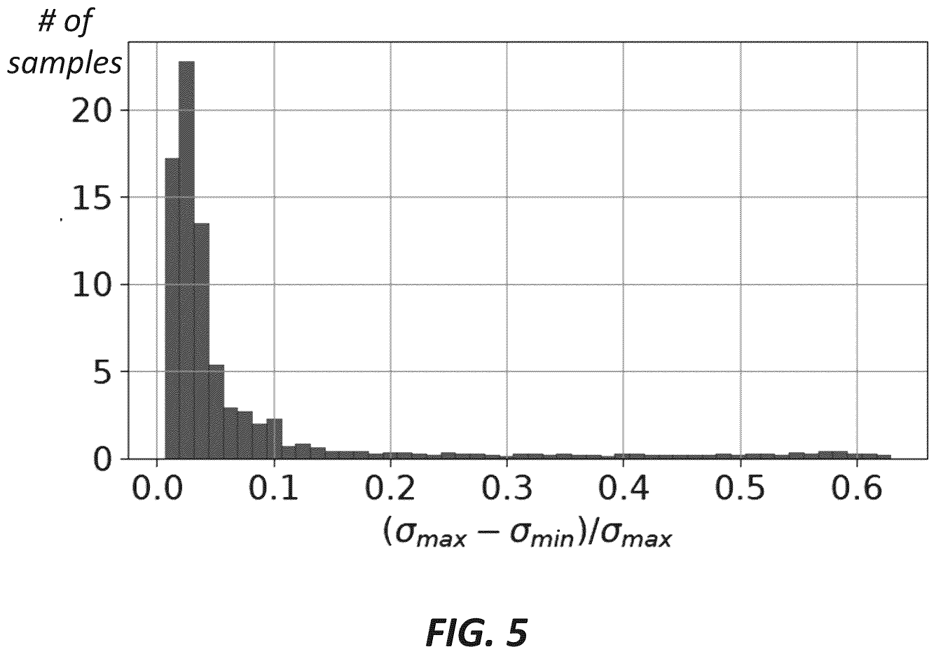

Plugging these push-forward operators into Equation (5), the pull-back of force correctness constraint in [symbol] may be obtained. However, a more succinct form of constraint may be derived when ϕ is made as conformal as possible (as described above). In this case, the Jacobian J(p̅ᵢ(t, c̅ₚⁱ)) is nearly a scaled rotation matrix: J≈UV^{T}|Σ|^{1/3}. By replacing J with such approximation in Equation (5), the constraint Equation (9) in [symbol] may be derived. Such constraint may be convex because the normal direction z is a constant and the spline f̅ᵢ linear in c̅_{f}ⁱ. Such a constraint can be handled more efficiently by optimizers than the non-convex Equation (5). Although Equation (9) is not an exact pull-back operator since the smooth map is not perfectly conformal, the difference is likely rather small as shown in FIG. 5, which illustrates a relative conformal error over a set of regularly sampled points on the example, terrain of FIG. 4A, extimated by relavtive difference between the maximal (σₘₐₓ) and minimal singular value (σₘᵢₙ) of J. FIG. 5 shows that most sample points have an error of less than 5% and that the average error in this example is 7.8%.

With respect to geometric constraints of Equation (4) relating to the second geometric constraint involving the extension range or reachability of the end-effectors of the robot relative to the robot's torso position p(t) and orientation R(t), the following pull-back form may be derived. For the torso position, a sequence p̅(t, c̅ₚ) in [symbol] may be introduced. In order to push-forward the orientation R, an arbitrary vector v∈ [symbol] that is brought to Jv∈ [symbol] may be considered. An orientation R can be considered as a matrix of three orthogonal vectors, which is brought to JR under the push-forward operator. However, the matrix JR∉SO(3) in general. Therefore, an additional projection operator [symbol] may be introduced. Given any J∈ [symbol] ^{3×3}, [symbol] (J) may map J to the nearest element of SO(3) in the following optimal sense:

$$𝒫 ( J ) {=}^{△} {argmin}_{R ϵ SO ( 3 )} {‖ R - J ‖}_{F}^{2} . \qquad ( 12 )$$

The above optimization has the following properties leading to the efficient computation of projection and its derivatives. Suppose the SVD decomposition of matrix J is J=UΣV^{T}. The projection operator has closed form solution [symbol] =UV^{T}|UV^{T}|. For any R∈SO(3), [symbol] (JR)= [symbol] (J)R. A closed form Jacobian of [symbol] may be derived as follows:

$$\frac{\partial 𝒫 ( J )}{\partial α} {=}^{△} ω \times 𝒫 ( J )$$

$$ω {=}^{△} {U ( tr \{ Σ \} I - Σ )}^{- 1} {V}^{T} [ {𝒫 ( J )}^{T} \frac{\partial J}{\partial α} - \frac{\partial {J}^{T}}{\partial α} 𝒫 ( J ) ] {\times }^{- 1} ,$$

where α represents some arbitrary variable of J and [⋅]x⁻¹ is the inverse cross product operator such that [⋅]x⁻¹x=⋅.

With the projection operator [symbol] above, the robot's torso rotation sequence in [symbol] may be defined as:

R(t) [symbol] [symbol] [J(p̅(t, c̅ₚ))]R(θ̅(t, c̅_{R})). (13)

In other words, Euler angles may first be used to define the rotation in [symbol] , which may be pushed forward to some element of [symbol] (ϕ(p̅(t, c̅ₚ))) which is then projected back to SO(3). The smooth map ϕ is C²-continuous. The rotation R(t) and force fᵢ(t) already depend on the Jacobian J. Further, R(t) and fᵢ(t) are only C¹-continuous. Plugging Equation (13) into the reachability constraint in Equation (4), its pull-back form in Equation (10) may be derived, which has well-defined Jacobian.

With respect to the physical constraints of Equation (2) in [symbol] , however, the pull-back may be more involved, as described in further detail below.

### Contact-Aware Trajectory Optimization in Warped Space: Position-Based Centroid Dynamics Model for Physical Constraints

The physical constraints of the Newton-Euler Equation (2) in [symbol] may be pulled back in [symbol] , similar to the pull-back form of the geometric constraints in Equation (10). However, such pull-back constraint would require R(t) to be C²-continuous when computing the constraint Jacobian, which could not always be achieved via ϕ discretized using cubic basis functions as described above. To obtain sufficient smoothness, one option would be using quartic basis functions, but this could significantly increase computational overhead of the smooth map optimization procedure, as well as all constraint evaluations.

In some example implementations, a Position-based Centroid Dynamics Model (PCDM) may be used handle the physics constraints in [symbol] . Such an approach would only require C¹ rather than C²-continuity.

Since the physics constraint is tested at a regular interval t∈ [symbol] as described above, the sampling interval may be denoted as Δt with the following shorthand notations:

⋅_=⋅(t−Δt) ⋅__=⋅(t−2Δt), (14)

In the notations above, ⋅ is an arbitrary variable. PCDM assumes that the physically correct configuration at time instance t is the minimizer of the following combined inertial and potential energy:

$$R , p = {argmin}_{R ϵ SO ( 3 ) , p} - {\sum }_{i} {\int }_{i}^{T} {p}_{i} ( t ) + \frac{ρ}{2 Δ {t}^{2}} {\int }_{xϵ Ω}$$

$$‖ ( Rx + p ) - 2 ( R … x + p … ) + {( R … x + p … )}^{2} d υ ,$$

where Ω is the volume occupied by the robot torso in its frame of reference.

With respect to time dependency, it can be shown that PCDM approximates the Newton-Euler's equation at the limit Δt→0, as illustrated below:

$${lim}_{t \to 0} \frac{ρ}{Δ {t}^{2}} {\int }_{xϵ Ω} ( 2 R … x - R … x ) \times Rxd υ$$

$$= - ρ {\int }_{xϵ Ω} ( \ddot{R} x ) \times Rxd υ$$

$$= ρ {\int }_{xϵ Ω} ( Rx ) \times ( \dot{w} \times + w \times w \times ) Rxd υ$$

$$= ρ {\int }_{xϵ Ω} - ( Rx ) \times ( Rx ) \times \dot{w} + ( Rx ) \times w \times w \times Rxd υ$$

$$= ρ {\int }_{xϵ Ω} - ( Rx ) \times ( Rx ) \times \dot{w} - w \times ( Rx ) \times ( Rx ) \times wd υ$$

$$= I \dot{w} + w \times Iw ,$$

where the vector identity of a×b×c+b×c×a+c×a×b=0 and the fact that I=∫_{x∈Ω}−(Rx)×(Rx)×dv are used.

By setting the gradient to be zero in the tangent bundle of SE(3), the PCDM governing Equation (11) may be derived, which only requires R(t), p(t) to be C¹-continuous. The integral in Equation (11) can be evaluated in the same way as the inertia tensor. As such, the cubic basis function for the smooth map ϕ is just enough for all the constraints in Equation (7) to have a well-defined Jacobian. Some optimizers require the Hessian of Lagrangian function, which is computed via low-rank approximation.

With all the constraints above, the optimization according to Equation (7) may be performed to generate the various control points in [symbol] which may then be mapped to [symbol] for generating the position, rotational, and force trajectories in [symbol] .

### Contact-Aware Trajectory Optimization in Warped Space: Evaluation

The baseline optimization (Equation (1)) and the reformulated optimization (Equation (7)) are both performed for evaluating the effectiveness of the warped space optimization in both optimization quality and ability to successfully find solutions. For fairness of comparison, PCDM is also used as physics constraints for the baseline formulation. All experiments are performed in a simulated environment using the ANYmal robot model. The largest rectangular reachable set to is extracted and used as [symbol] .

As an example, Knitro package is used as the optimizer backend. The maximal number of iterations is set to be 200 and the optimizer is configured to terminate early if the maximal constraint violation is smaller than 10⁻⁴ or the relative solution change is smaller than 10⁻⁴ over 5 consecutive iterations. All experiments are performed on a desktop machine with a 6-core Intel i7-10750H CPU and 8 Gb memory. Multi-thread is used to accelerate the computation of constraints and their Jacobian. The various parameters as set as T=10 s, v=0.75, and Δt=0.05 s. All the trajectories, including position, orientation, and force, are discretized using cubic B-splines. On average over all examples, a trajectory of 10 seconds can be computed in around 1 minute using the approach involving the warped space.

The performance of smooth map ϕ optimization (Equation (6)) is first profiled and compare the two solutions: local-global (Algorithm 1) and Newton's approach using the terrain of FIG. 4A-4D. As illustrated in FIGS. 6A-6H, the local-global approach converges much faster than the Newton's approach. In particular, FIGS. 6A, 6C, 6E, and 6G show minimized energy as a function of computation time for FIGS. 4A-4D, whereas FIGS. 6B, 6D, 6F, and 6H show correspondingly minimized energy as a function of number of optimization iterations. Although the local-global approach can generate non-injective maps, this artifact has not been observed in benchmarks of FIG. 4A-FIG. 4D. As such, in some implementations, the local-global approach is used first and the more costly Newton's method is reverted to only if injectivity in the local-global approach is violated. For most examples, the smooth map ϕ can be optimized within 200 s. In order to ensure that the robot never leaves the narrow band ambient space, the band thickness is sufficiently set to be 5 times that of the robot height at its rest pose, as illustrated in FIGS. 4A-4D.

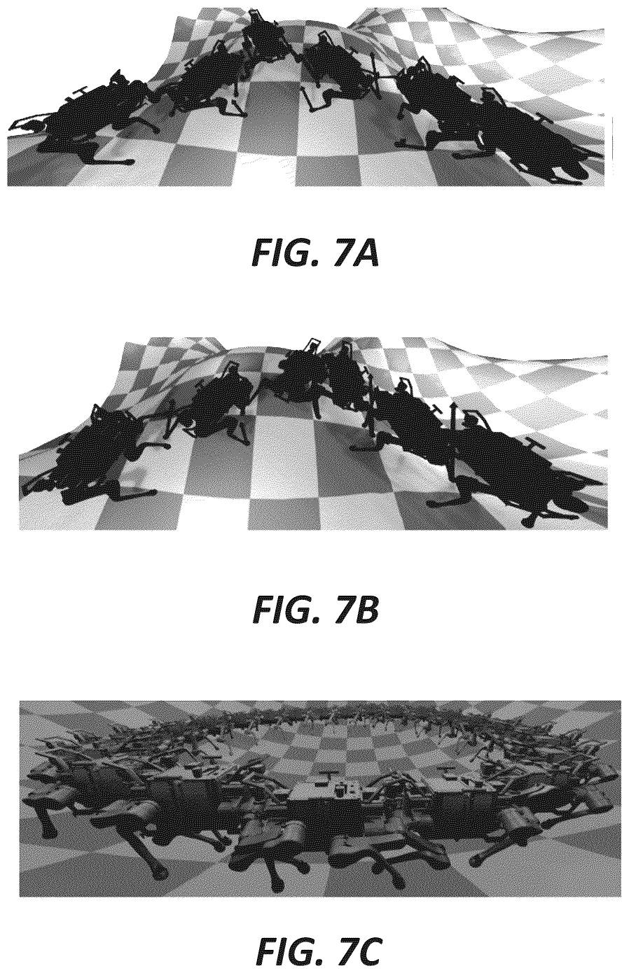

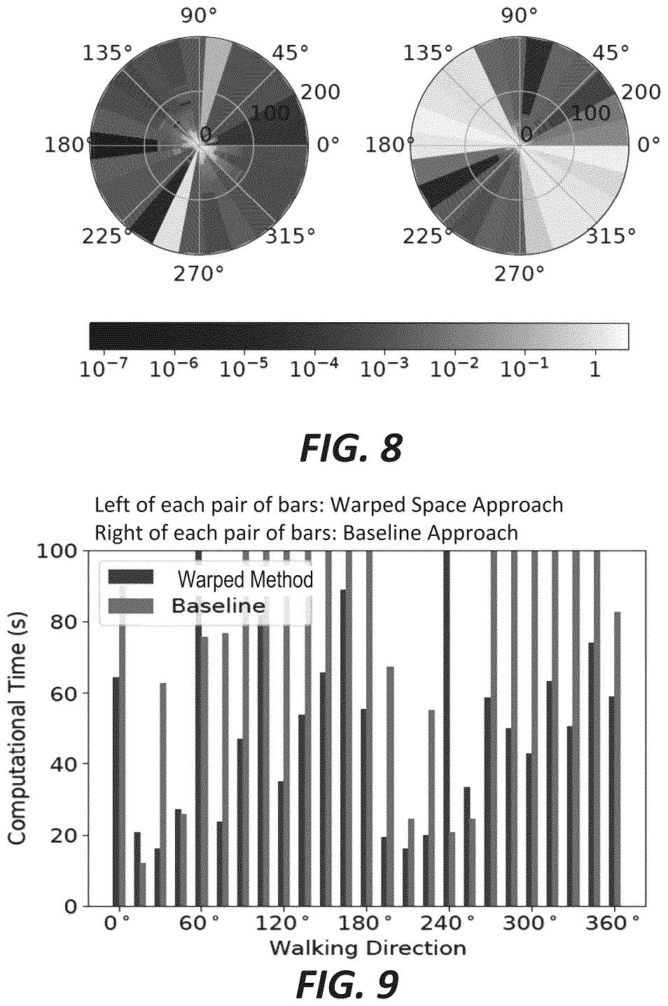

A first benchmark (FIG. 7A and FIG. 7B) uses the rippled terrain (FIG. 4A). The robot is initialized in the center of this terrain (0,0) and robot is configured to move to the horizontal point (rsin θ/2, rcos θ/2) where r is half the size of the terrain. The target position is added as a hard constraint on the X-Y plane. θ is sampled from 0° to 360° at an interval of 15°. For each θ, optimization is run for a maximum of 200 iterations and the per-iteration constraint violation is ploted in in FIG. 8. A trajectory is deemed successful if the maximal constraint violation is less than 10⁻⁴ within 200 iterations. Under this criterion, the warped space approach (FIG. 7A and left panel of FIG. 8) achieves a success rate of 92%, which is significantly higher than 48% using the baseline formulation (FIG. 7B and right panel of FIG. 8).

The computational overhead of the two methods is further compared in FIG. 9. In FIG. 9, the left and right bar of each pair of bars is for the warped space approach and the baseline approach, respectively. As shown in FIG. 9, except for 1-2 walking directions, the warped space method incurs a lower computational overhead by using fewer iterations to converge.

A second benchmark (FIG. 7C) uses the conic terrain of FIG. 4B. All other settings are kept the same as the first benchmark except that the robot is horizontally initialized at (−rsin θ/2, −rcos θ/2), so that the robot needs to walk over a longer distance. In this more challenging case, the baseline formulation achieves a success rate of 0% as compared with 100% using the warped space approach disclosed herein.

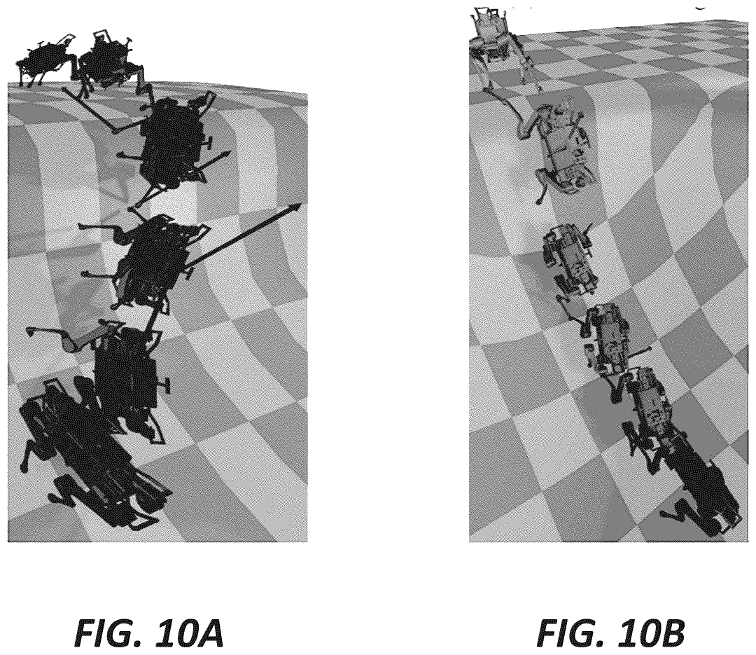

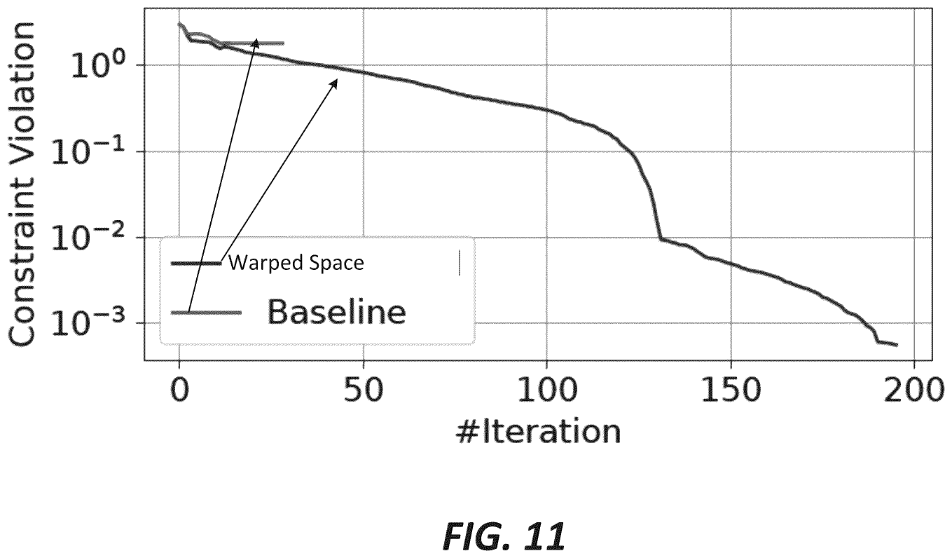

A third benchmark (FIG. 10A) uses the hilly terrain in FIG. 4C. The slope of the hill in the middle is rather steep. Therefore, the robot is allowed to climb the hill by modeling its two front legs with suckers, allowing it to apply adhesive forces by removing two of the frictional cone constraints. As an example, 15 target positions uphill are uniformed sampled. The success rate of the warped space approach and the baseline approach are 100% and 0%, respectively. Indeed, it is difficult for low-order polynomial curves to fit the drastically changing terrains, while the warped space approach allows for a straight line in the warped space to align with the environment in the ambient space. The average per-iteration constraint violation of one trajectory is plotted in FIG. 11.

Similarly, a fourth benchmark (FIG. 10B) uses the terrain in FIG. 4D, which has a deep pit in the middle, with a much sharper cliff than that of the hill in FIG. 4C. As an exmaple, 15 target positions outside the pit are uniformed sampled. The warped space method achieves a success rate of 13%, as compared with 0% using the baseline.

The various success rates above of both the warped space approach disclosed herein and the baseline approach are summarized in Table 1.

### Hardware Platform

The techniques described above, may be be implemented using specifically

TABLE 1
Success rate of both methods on four benchmarks of FIGS. 4A-4D.

| Terrain | FIG. 4A | FIG. 4B | FIG. 4C | FIG. 4D |
|---|---|---|---|---|
| Warped Space Method | 92% | 100% | 100% | 13% |
| Baseline Method | 48% | 0% | 0% | 0% |

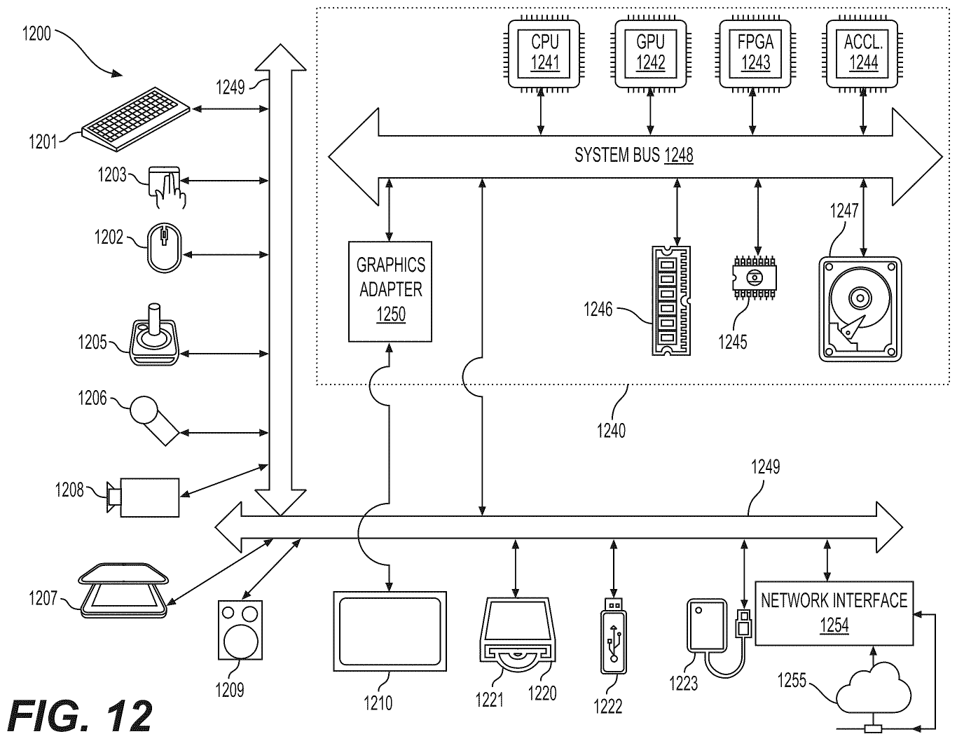

designed processors and memories in any electronic devices or may be implemented as computer software or firmware using computer-readable instructions and physically stored in one or more computer-readable media. For example, FIG. 12 shows an electronic device or computer system (1200) suitable for implementing the embodiments of the disclosed subject matter.

The computer software or firmware can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), FPGAs, dedicated processing units, and the like.

The instructions can be executed on various types of computers or components thereof, including, for example, personal computers, tablet computers, servers, smartphones, gaming devices, internet of things devices, and the like.

The components shown in FIG. 12 for computer system (1200) are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system (1200).

Computer system (1200) may include input interface devices. Such a input interface device may be responsive to input by one or more users through, for example, tactile input (such as: keystrokes, swipes, data glove movements), audio input (such as: voice, clapping), visual input (such as: gestures), olfactory input (not depicted). The input interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video). The input interfaces may be used to input parameters and commands for the sand-water simulations above or for interactively controlling various graphics generated based on the sand-water simulations above.

The input interface devices may include one or more of (only one of each depicted): keyboard (1201), mouse (1202), trackpad (1203), touch screen (1210), data-glove (not shown), joystick (1205), microphone (1206), scanner (1207), camera (1208).

Computer system (1200) may also include certain output interface devices. Such output interface devices may be configured to stimulate senses of users through, for example, tactile output, sound, light, touch, smell/taste, and the like. Such output interface devices may include tactile input and output combination devices (for example tactile feedback by the touch-screen (1210), data-glove (not shown), or joystick (1205), but there can also be tactile feedback devices that do not serve as input devices), audio output devices (such as: speakers (1209), headphones (not depicted)), visual output devices (such as display screens (1210) including but not limited include CRT display screens, LCD display screens, plasma display screens, OLED screens, and projection displays, each with or without touch-screen input capability, each with or without tactile feedback capability—some of which may be capable to output two dimensional visual output or three-dimensional output through means such as stereoscopic graphic output; virtual-reality glasses (not depicted), holographic displays and smoke tanks (not depicted)). The output interface devices may include other devices such as two-dimensional or three-dimensional printers (not depicted).

Computer system (1200) can also include non-transitory storage devices and their associated media such as optical media including CD/DVD ROM/RW (1220) with CD/DVD or the like media (1221), thumb-drive (1222), removable hard drive or solid state drive (1223), legacy magnetic media such as tape and floppy disc (not depicted), specialized ROM/ASIC/PLD based devices such as security dongles (not depicted), and the like. Those skilled in the art should also understand that term “computer readable media” as used in connection with the presently disclosed subject matter does not encompass transmission media, carrier waves, or other transitory signals.

Computer system (1200) can also include an interface (1254) to one or more communication networks (1255). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G/LTE, 5G networks and the like, TV wireline or wireless wide area digital networks to include cable TV, satellite TV, and terrestrial broadcast TV, vehicular and industrial to include CAN bus, and so forth. The computer system (1200) may be connected to various external networks via network interface adapters that attached to general-purpose data ports or peripheral buses (1249) (such as, for example, USB ports) of the computer system (1200)). The network interfaces may alternatively be integrated into the core of the computer system (1200) by via system buss as described below (for example, Ethernet interface or cellular communication interface may be integrated into a PC computer system or smartphone computer system). Using any of these communication networks, the computer system (1200) can communicate with other remote electronic devices. Such communication can be uni-directional (e.g., receive-only (for example, broadcast TV), or transmit-only (for example CANbus to certain CANbus devices) or bi-directional (for example, both receive from and transmit information to other computer systems using local or wide area digital networks). A collection of protocols and protocol stacks can be used on each of those networks and network interfaces to effectuate network communications.

Aforementioned input and output interface devices, storage devices, and network interfaces can be attached to a core (1240) of the computer system (1200).

The core (1240) can include one or more Central Processing Units (CPU) (1241), Graphics Processing Units (GPU) (1242), specialized programmable processing units in the form of Field Programmable Gate Areas (FPGA) (1243), hardware accelerators for certain tasks (1244), graphics adapters (1250), and the like. These devices, along with Read-only memory (ROM) (1245), Random-access memory (1246), internal mass storage such as internal non-user accessible hard drives, SSDs, and the like (1247), may be connected through a system bus (1248). In some computer systems, the system bus (1248) can be accessible in the form of one or more physical connectors to enable extensions by additional CPUs, GPU, and the like. The peripheral devices can be attached either directly to the core's system bus (1248), or through a peripheral data bus (1249). In an example, the display screen (1210) can be connected to the graphics adapter (1250). Architectures for a peripheral bus may include but is not limited to PCI, USB, and the like. The CPUs (1241), GPUs (1242), FPGAs (1243), and accelerators (1244) can execute computer instructions as the aforementioned computer code. Such computer code can be stored in the ROM (1245) or RAM (1246). Intermediate processing data can also be stored in RAM (1246), whereas permanent data can be stored for example, in the internal mass storage (1247). Fast storage to and retrieval from any of the memory devices can be enabled through the use of cache memory. The cache memory may be integrated with or otherwise in direct communication with the one or more CPU (1241), GPU (1242), mass storage (1247), ROM (1245), RAM (1246), and the like.

The computer readable media may be configured to store computer code thereon for performing various computer-implemented operations. The media and computer code can be those specially designed and constructed for the purposes of the present disclosure, or they can be of general purpose.

As a non-limiting example, the computer system having architecture (1200), and specifically the core (1240) can provide functionality as a result of the processor(s) (including CPUs, GPUs, FPGA, accelerators, and the like) executing software embodied in one or more tangible, computer-readable media. Such computer-readable media can be implemented as the mass storage as described above, as well as certain storage of the core (1240) that are of non-transitory nature, such as core-internal mass storage (1247) or ROM (1245). The software for implementing the various embodiments of the present disclosure can be stored in such devices and executed by the computer core (1240). A computer-readable medium can include one or more memory devices or storage chips. The software can be executed to cause the computer core (1240) and specifically the processors therein (including CPU, GPU, FPGA, and the like) to execute particular processes or particular parts of particular processes described herein, including defining data structures stored in RAM (1246) and modifying such data structures according to the processes defined by the software. In addition or as an alternative, the computer system (1200) can provide functionality as a result of logic hardwired or otherwise embodied in a circuit (for example: accelerator (1244)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) for storing software for execution, a circuit embodying logic for execution, or both, where appropriate. The present disclosure encompasses any suitable combination of hardware and software.

In general, terminology may be understood at least in part from usage in its context. For example, terms, such as “and”, “or”, or “and/or,” as used herein may include a variety of meanings that may depend at least in part upon the context in which such terms are used. Typically, the term “or”, if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for the existence of additional factors not necessarily expressly described, again, depending at least in part on context.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed:

1. A method for computer generation of a gait trajectory as a function of time for a legged robot moving from an origin to a destination over an ambient terrain, the method comprising:
establishing a flat terrain and a narrow flat neighborhood band above the flat terrain, the flat terrain and the narrow flat neighborhood band forming a three-dimensional (3D) flat space;
automatically generating, using a first optimization procedure for minimizing a first objective function, a mapping function from the 3D flat space to a 3D ambient space encompassing the ambient terrain;
automatically generating, using a second optimization procedure under a set of motion constraints and by minimizing a second objective function, a set of control points and time spans in the 3D flat space for parameterizing the gait trajectory using high-order spines; and
automatically generating the gait trajectory of the legged robot in the 3D ambient space from the origin to the destination based on the set of control points in the 3D flat space, the time spans, and the mapping function.

2. The method of claim 1, wherein the 3D ambient space and the 3D flat space are discretized using a finite element procedure with high-order shape functions.

3. The method of claim 2, wherein the 3D flat space is discretized into a regular grid of B-spine cells and the mapping function for each spatial dimension in the 3D flat space comprises a linear combination of the high-order shape functions.

4. The method of claim 2, wherein the high-order shape functions are C² continuous.

5. The method of claim 2, wherein the first objective function comprises an integrated energy measure and a terrain mismatching measure.

6. The method of claim 5, wherein the integrated energy measure is configured to represent a mapping conformity.

7. The method of claim 6, wherein the mapping conformity, when minimized, maximizes a preservation of angles between the 3D flat space and the 3D ambient space by the mapping function.

8. The method of claim 5, further comprising receiving a height profile of the ambient terrain in the 3D ambient space, wherein the terrain mismatching measure is configured to quantify a deviation of the flat terrain in the 3D flat space mapping to the ambient terrain in the 3D ambient space via the mapping function, the ambient terrain being represented by the height profile.

9. The method of claim 5, wherein the first optimization procedure comprises an iterative process of both local and global optimization.

10. The method of claim 1, wherein:
the legged robot comprises a torso attached with a plurality of end-effectors; and
the gait trajectory of the legged robot is represented by a torso position, a torso orientation, end-effector positions, and end-effector forces, each as a function time.

11. The method of claim 10, wherein the set of motion constraints comprise a set of geometrical constraints, a set of physical motion constraints, and a force constraint.

12. The method of claim 11, wherein:
the set of physical motion constraints comprise Newton-Euler's equations relating the end-effector forces and gravity to a translation and rotation of the legged robot; and
the force constraint requires that the end-effector forces lie within a fraction cone during contacts of the end-effectors with the ambient terrain.

13. The method of claim 12, wherein the set of geometrical constraints comprise:
the end-effector positions being on or above the ambient terrain in the 3D ambient space; and
the end-effector positions being within a reachable set of distances relative to the torso position in the 3D ambient space.

14. The method of claim 13, wherein the set of geometric constraints are represented in the 3D flat space by pulling back the set of geometric constraints from the 3D ambient space.

15. The method of claim 14, wherein the set of physical motion constraints and the force constraint are tested during the second optimization procedure at a fixed set of time instances.

16. The method of claim 15, wherein the set of physical motion constraints are represented by a Position-based Centroid Dynamics Model (PCDM) in a push-forward form in the 3D ambient space.

17. The method of claim 16, wherein the physical motion constraints are represented as a minimizer of a combined inertial and potential energy.

18. The method of claim 14, wherein the set of control points in the 3D flat space comprise:
a first set of control points for the torso position in the 3D flat space;
a second set of control points for the torso orientation in the 3D flat space;
a third sets of control points for the end-effector positions in the 3D flat space; and
a fourth sets of control points for the end-effector forces in the 3D flat space.

19. The method of claim 18, wherein the second objective function uses the set of control points as optimization variables.

20. An electronic device comprising a memory for storing computer instructions and a processor configured to read the computer instructions from the memory and execute the computer instructions to:
establish a flat terrain and a narrow flat neighborhood band above the flat terrain, the flat terrain and the narrow flat neighborhood band forming a three-dimensional (3D) flat space;
automatically generate, using a first optimization procedure for minimizing a first objective function, a mapping function from the 3D flat space to a 3D ambient space encompassing an ambient terrain;
automatically generate, using a second optimization procedure under a set of motion constraints and by minimizing a second objective function, a set of control points and time spans in the 3D flat space for parameterizing a gait trajectory as a function of time using high-order spines for a legged robot from an origin to a destination over the ambient terrain; and
automatically generate the gait trajectory of the legged robot in the 3D ambient space based on the set of control points in the 3D flat space. The time spans, and the mapping function.
